(19) United States
(12) Patent Application Publication
(10) Pub. No.: US 2008/0104709 A1
(43) Pub. Date: May 1, 2008

(54) SYSTEM AND METHOD FOR SECURE DATA STORAGE

(75) Inventors: Kelton AVERYT, Bay View, TX (US); Martin Henderson, South Padre Island, TX (US); John Morabito, Dunn Loring, VA (US); Bob Bennett, Arlington, VA (US); Bob Schmid, Vienna, VA (US)

Correspondence Address: FOLEY AND LARDNER LLP;SUITE 500, 3000 K STREET NW, WASHINGTON, DC, 20007, US

(73) Assignee: VERUS CARD SERVICES

(21) Appl. No.: 11/537,260

(22) Filed: Sep. 29, 2006

(51) Int. Cl. H04L 9/32; G06F 17/30; G06F 12/14; G06F 7/04; G06K 9/00; G06F 11/30; H03M 1/68; H04K 1/00; H04L 9/00; H04N 7/16; G06F 15/16; G06F 17/00; G06F 9/00

(52) U.S. Cl. 726/27; 713/189; 713/193; 726/30; 705/64; 726/11

(57) ABSTRACT

A system and method for secure data storage is provided. A host system sends data to a secure storage processor where it is encrypted, stored, and a globally unique identifier is transmitted to the host system. The globally unique identifier is associated with the stored encrypted data and can be used in future interactions with the secure storage processor, such as a transaction request. A host system will transmit a transaction request and a globally unique identifier to the secure storage processor. The secure storage processor will process the transaction utilizing the stored encrypted data associated with the globally unique identifier, and will transmit a response indicating the failure or success of the transaction. In addition, the system is configured to facilitate information retrieval, wherein the secure storage processor sends the stored encrypted data to a requesting host system.

### FIELD OF THE INVENTION

The present invention relates generally to data storage. More specifically, the present invention relates to a method for securely storing data.

### BACKGROUND

The storage of data always presents a challenge for the architect of any computer system. There are many considerations when designing a data storage system. Various considerations include potential hardware failure, speed of storage, data consistency, recovery time from hardware failure, and security of the stored data.

Traditionally, users of computer systems stored their data either locally or on a remotely accessible storage device. In both the local and remote storage cases, the architect of the computer system was responsible for all of the considerations outlined above. Designing such a system is a complex challenge. Further, the considerations mentioned above are more acute when data concerning financial transactions or sensitive personal information is involved. Examples of data in these highly sensitive areas includes, for example, credit card information, automated clearing house information, and social security number information.

A further level of complexity is introduced when attempting to perform these transactions in a secure and verifiable manner. For example, currently, merchants may store sensitive information concerning their customers such as credit card information or a social security number. The merchant also executes its own software to perform financial transactions using the sensitive customer information. The merchants' software ultimately interacts with multiple payment networks to complete transactions. The critical issue under conventional transaction processing architecture is that the merchant bears significant risk by storing sensitive customer data and bears the responsibility in creating a secure and verifiable transaction processor to insure that the data is not compromised.

Therefore, a method and system for securely storing, retrieving and transmitting sensitive data is needed.

### SUMMARY

The present invention addresses the above-identified considerations of securely storing sensitive data and performing secure transactions involving sensitive data. A host system transmits a request to store data on a secure storage processor. The request to store data is received by a secure storage processor. Once the secure storage processor has received the request to store data from the host system, it encrypts the data, stores the encrypted data, and generates a unique identification number which identifies the stored encrypted data. The unique identification number is transmitted from the secure storage processor to the host system. The host system receives the unique identification number and stores the unique identification number.

According to another embodiment of the present invention, a secure storage processor receives a request to store data from a host system. Once the secure storage processor has received the request to store data from the host system, it encrypts the data, stores the encrypted data and generates a globally unique identifier which identifies the stored encrypted data. The unique identification number is transmitted from the secure storage processor to the host system.

According to still another embodiment of the present invention, a secure storage processor for storing encrypted data receives a request to process a transaction from a host system, wherein the request includes a globally unique identifier associated with the stored encrypted data in the secure storage processor. The secure storage processor processes the transaction. A response indicating the status of the transaction is then sent to the host system.

According to another embodiment of the present invention, a secure storage processor, storing encrypted data, receives a request from a host system to retrieve the securely stored encrypted data, wherein the request includes a globally unique identifier associated with the stored encrypted data. The secure storage processor retrieves the requested stored encrypted data associated with the globally unique identifier, and decrypts the stored encrypted data. A response indicating the status of the request is then sent to the host system.

According to another embodiment of the present invention, a host system receives a user request to perform a credit card transaction with credit card data. The host system transmits the credit card data from the host system to a secure storage processor. The secure storage processor receives the credit card data from the host system, encrypts the credit card data, and stores the encrypted credit card data. The secure storage system generates and transmits a globally unique identifier identifying the encrypted credit card data from the secure storage processor to the host system. The host system stores the globally unique identifier received from the secure storage processor. The secure storage processor receives a request to process a credit card transaction from the host system, wherein the request includes a globally unique identifier associated with the encrypted credit card data stored in the secure storage processor. The secure storage processor processes the credit card transaction. A response indicating the status of the credit card transaction is then sent to the host system.

According to yet another embodiment of the present invention, a host system transmits data to a secure storage processor. The host system receives a globally unique identifier identifying the stored encrypted data from the secure storage processor, and the host system stores the globally unique identifier.

According to another embodiment of the present invention, a system for securely storing data comprises a host system, and a secure storage processor connected to the host system via a network. The secure storage processor is configured to receive data from the host system, encrypt the data, store the encrypted data, and transmit a globally unique identifier identifying the stored encrypted data to the host system.

According to still another embodiment of the present invention, a system for processing securely stored data comprises a host system, and a secure storage processor connected to the host system via a network. The secure storage processor is configured to receive a request from the host system to process a transaction and a globally unique identifier associated with stored encrypted data in the secure storage processor, process the transaction and return a response to the host system indicating the status of the transaction.

These and other objects, advantages and features of the invention, together with the organization and manner of operation thereof, will become apparent from the following detailed description when taken in conjunction with the accompanying drawings, wherein the like elements have numerals throughout the several drawings described below.

### BRIEF DESCRIPTION OF THE DRAWINGS

FIG. 1 is a block diagram of a system for secure data storage according to one embodiment of the present invention.

FIG. 2 is a block diagram illustrating a method for secure data storage according to one embodiment of the present invention.

FIG. 3 is a block diagram illustrating a method for processing a financial transaction according to one embodiment of the present invention.

FIG. 4 is a block diagram illustrating a method for processing a credit card transaction according to one embodiment of the present invention.

FIG. 5 is a block diagram illustrating a secure storage processor servicing multiple clients according to one embodiment of the present invention.

FIG. 6 is a block diagram illustrating a method for processing multiple storage requests according to one embodiment of the present invention.

FIG. 7 is a block diagram illustrating a method for retrieving securely stored data according to one embodiment of the present invention.

### DETAILED DESCRIPTION

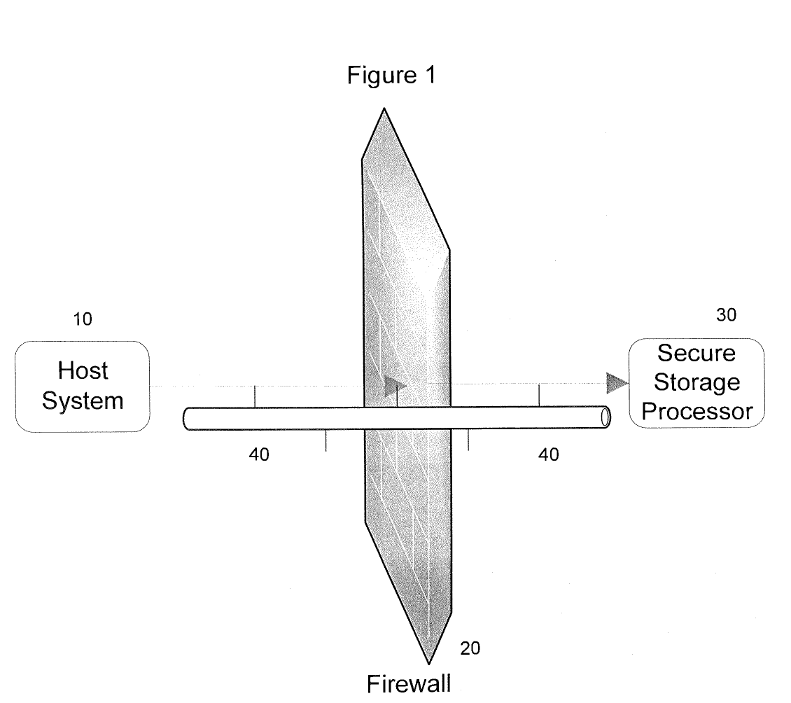

FIG. 1 shows a block diagram of a system for secure data storage according to one embodiment of the present invention. A host system 10 and a secure storage processor 30 are shown. The host system 10 communicates with the secure storage processor 30 through a network 40. The network 40 over which the host system 10 and the secure storage processor 30 communicate, could be ethernet, wi-fi, token ring, or any other networking technology. Additionally, all communication between the host system 10 and the secure storage processor 30 is received through a firewall 20. A firewall 20 is software or hardware configured to protect a system receiving information by preventing unauthorized communications with the system based on a set of security policies. Accordingly, a firewall 20 increases the security of a system by preventing the unauthorized transmission of information..

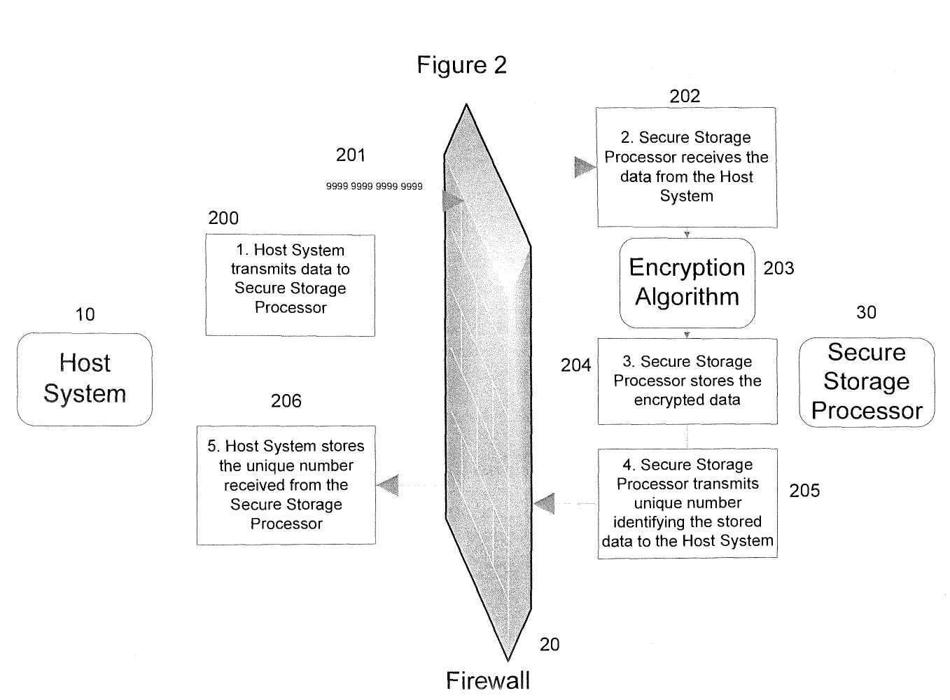

FIG. 2 shows a block diagram of a method for secure data storage according to one embodiment of the present invention. A host system 10 and secure storage processor 30 are shown. The host system 10 transmits data to the secure storage processor 30 (step 200). Various types of data including financial data and personal information can be transmitted by the host system 10. Examples include social security information, credit card information, or automated clearing house information. FIG. 2 shows, for example, credit card information 201 being transmitted by the host system 10 to the secure storage processor 30. The secure storage processor 30 receives the transmission from the host system 10 through a network firewall 20. Once the secure storage processor 30 has received the data from the host system 10 (step 202), the secure storage processor 30 encrypts the data (step 203). Then, the secure storage processor 30 stores the encrypted data (step 204).

The encrypted data can be stored in a number of different ways. In one embodiment of the present invention, the secure storage processor 30 utilizes a database management system for data storage. Alternatively, a secure file system or non-volatile random access memory system could be used for storing the encrypted data. Following the storage of the transmitted data (step 204), the secure storage processor 30 generates and transmits a globally unique identifier associated with the stored encrypted data to the host system 10 (step 205).

The globally unique identifier is a series of characters such as letters, numbers or symbols that is associated with and identifies the stored encrypted data in the secure storage processor 30. The host system 10 receives the globally unique identifier from the secure storage processor 30 and stores the globally unique identifier (step 206). The globally unique identifier can later be used by the host system 10 to easily refer to the stored encrypted data in future interactions with the secure storage processor 30.

Therefore, the host system 10 according to FIG. 2 is not burdened with the difficulties encountered when designing a sophisticated secure storage system. Various considerations include potential hardware failure, speed of storage, data consistency, recovery time from hardware failure, and security of the stored data. Each of these considerations is mitigated through many system design techniques. An example of a mechanism for mitigating the effects of hardware failure is the various styles and types of raid arrays available in the art. However, raid arrays and the like are difficult, complex, and time-consuming to implement. Accordingly, the host system 10 in FIG. 1 need not concern itself with the design and implementation details of mitigating these design considerations. Rather, a separate secure storage processor 30 is designed to handle all the considerations involved with secure storage.

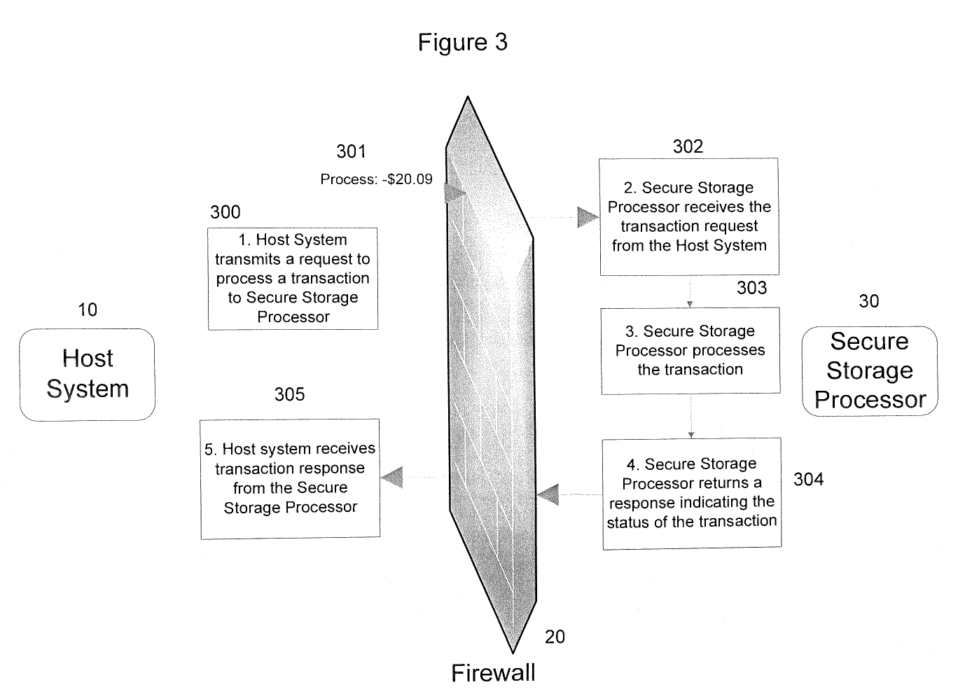

FIG. 3 illustrates an example of the host system 10 using the globally unique identifier in a transaction with the secure storage processor 30. FIG. 3 is a block diagram of a method for executing a transaction according to one embodiment of the present invention. A host system 10 and secure storage processor 30 are shown. The secure storage processor 30 communicates with the host system 10 through a network firewall 20. The host system 10 transmits a transaction request to the secure storage processor 30, wherein the request includes a globally unique identifier associated with stored encrypted data in the secure storage processor 30 (step 300).

A transaction request can be any one of a number of transactions. Transactions may be related to personal information transactions as well as financial transactions. A personal information transaction is a transaction wherein personal information is manipulated or utilized. Typically, personal information transactions occur when one party or entity is utilizing or manipulating the personal information of an individual. Personal information transactions can be performed by utilizing or manipulating many different types of personal information. As an example, a personal information transaction may be a transaction utilizing an individual's social security information. Alternatively, a personal information transaction may utilize or manipulate personal health insurance information. For instance, an individual's health insurance record could be updated through a personal information transaction.

A financial transaction is a transaction wherein moneys are transferred from at least one party or entity to another party or entity. Typically, financial transactions occur when an individual is purchasing goods or services, and the financial transaction is the method by which the individual is purchasing those goods or services. Alternatively, a financial transaction can be a single entity or party transferring moneys to multiple entities or parties, as is the case when an employer is depositing multiple employees' bimonthly salaries. Financial transactions can be performed utilizing many different types of financial information. For example, a transaction may be a credit card transaction utilizing credit card information. Alternatively, a financial transaction may utilize automated clearing house data, debit card data, bank account data, checking data, electronic funds transfer (EFT) data, or automated teller machine data. For instance, a financial transaction may be a credit card transaction requested by a merchant to be performed on credit card information which was previously stored in the secure storage processor 30. FIG. 3 shows a generic financial transaction.

Once the secure storage processor 30 has received the transaction request from the host system 10 (step 302), the secure storage processor 30 processes the transaction (step 303) utilizing the encrypted data associated with the globally unique identifier. The manner in which each transaction is performed will vary by the type of transaction. As disclosed above, one of the many types of transactions which could be performed by the secure storage processor 30 is the depositing of money into an employee's account. This transaction is accomplished by the secure storage processor 30 through the inter-bank transfer system which utilizes automated clearing house data. The secure storage processor 30 insures that the transaction is performed securely and verifies the result to ensure the atomicity and completeness of the transaction.

Following the processing of the transaction, the secure storage processor 30 generates and transmits a response indicating the status of the transaction (step 304). The host system 10 receives the transaction response from the secure storage processor 30 (step 305). The transaction response indicates to the host system 10 whether the transaction was a success or a failure. More specifically, the transaction status depends on the type of transaction that was performed. As an example, a credit card transaction may have a number of status responses. Some of those may be classified as successes, while others may be classified as failures. For example, the secure storage processor 30 may respond that the card number on file is no longer valid, the account is overdrawn, or that the account does not allow debiting of the amount specified in the transaction.

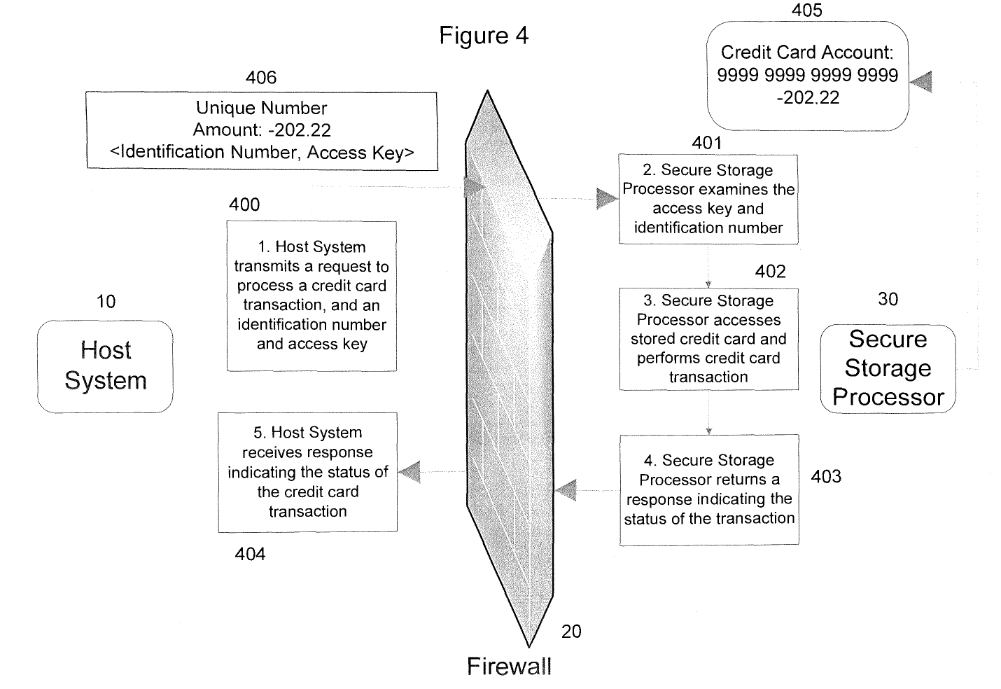

The present invention may be utilized to perform a number of transactions. As an example, FIG. 4 is a block diagram for a method of processing a credit card transaction according to one embodiment of the present invention. A host system 10 and secure storage processor 30 are shown. The host system 10 transmits a credit card transaction request (step 400) to the secure storage processor 30. In addition, the host system 10 may also submit an identification number and/or user name and access keys and/or passwords to the secure storage processor 30 for authentication purposes. For example, the host system 10 may transmit a transaction requesting that $202.22 be debited from the card associated with a globally unique identifier 406.

The secure storage processor 30 communications with the host system 10 through a network firewall 20. Once the secure storage processor 30 has received the communication from the host system 10, if the host system 10 transmitted an identification number and access key, the secure storage processor 30 examines the identification number and access key to determine whether the access key matches the identification number prior to proceeding with the credit card transaction (step 401). The purpose of the identification number and access key is to securely verify the identity of the host system 10 before performing any further operations.

Following the evaluation of the access key and identification number (step 401), the secure storage processor 30 accesses the stored encrypted credit card information (step 402). The secure storage processor 30 accesses the stored encrypted credit card information via the globally unique identifier transmitted with the credit card transaction request, wherein the globally unique identifier is associated with specific stored encrypted data at the secure storage processor 30. In this case, the specific encrypted data is the credit card information needed for the transaction. The secure storage processor 30 uses the retrieved credit card information to perform the requested credit card transaction (step 402). The successful result of a credit card transaction could be the deduction of an amount of money from a credit card account 405. Following the processing of the credit card transaction, the secure storage processor 30 generates and transmits a response indicating the status of the transaction (step 403). The host system 10 receives the credit card transaction response from the secure storage processor 30 (step 404). The response indicates to the host system 10 whether the transaction was a failure or a success.

There are several advantages to performing sensitive data transactions on a system separate from the host system 10. The host system 10 in FIG. 4 is not burdened with the difficulties encountered when designing a complex transaction handling system designed to be both secure and readily verifiable. A separate secure storage processor 30 is designed to handle all the considerations involved in designing both the secure storage system and the transaction handling system. The host system 10 merely requests that transactions be performed, and is subsequently informed as to the success or failure of the requested transactions.

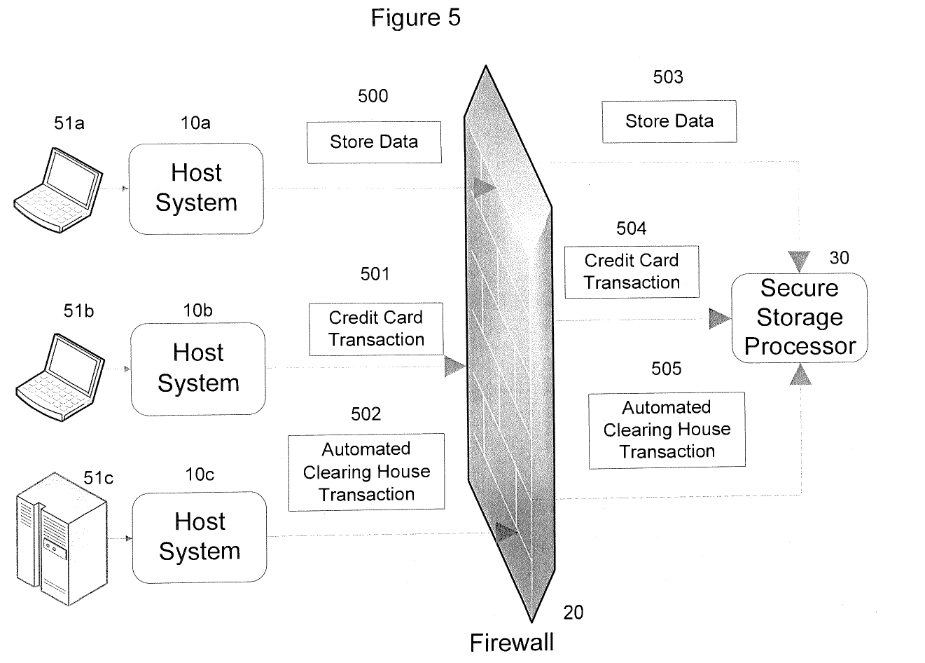

The present invention may also be utilized by a number of separate host systems concurrently. FIG. 5 is a block diagram for a secure storage processor 30 servicing multiple clients according to one embodiment of the present invention. There are a number of host systems in FIG. 5 interacting concurrently with the secure storage processor 30. Host system 10a interacts with the secure storage processor 30 by sending it a store data request (step 500). The store data request (step 500) may come from a third party user interacting with host system 10a through a web-based application 51a. For example, the user of the web-based application 51a may wish to store a credit card on an online shopping web-site hosted by host system 10a. Thus, through the use of the secure storage processor 30, host system 10a does not have to store the sensitive credit card information.

Host system 10b interacts with the secure storage processor 30 by sending a credit card transaction request (step 501). The credit card transaction (step 501) may come from a third party user 51b interacting with the host system 10b through a web-based application. The user 10b may be purchasing an item through an online shopping site hosted by host system 10b. Here, through the use of the secure storage processor 30, host system 10b does not bare the burden of executing the credit card transaction handling process.

Host system 10c interacts with the secure storage processor 30 by sending it an automated clearing house transaction (step 502). The automated clearing house data transaction (step 502) may originate from a third party user 51c. A user 51c may be an employer seeking to deposit money into any employee's bank account. Accordingly, host system 10c does not bare the burden of storing sensitive automated clearing house data or executing the funds transfer transaction handling process.

The secure storage processor 30 receives transaction requests from each of the host systems through a network firewall 20. The store data request (step 503) originating from host system 10a is serviced by the secure storage processor 30 as described in FIG. 1 and the accompanying explanation. The credit card transaction request (step 504) originating from host system 10b is serviced by the secure storage processor 30 as described in FIG. 3 and the accompanying explanation. The automated clearing house transaction request (step 505) originating from host system 10c relates to a system for debiting money from an account. The automated clearing house transaction is serviced by the secure storage processor 30 in the same manner as described in FIG. 3 and the accompanying explanation.

A secure storage system for handling a number of separate hosts concurrently has several advantages. For example, none of the host systems in FIG. 5 are burdened by the complexity of designing a secure storage system or a transaction handling system. Rather, there is a separate secure storage processor 30 which is designed to handle all the considerations involved in designing both the secure storage system and the transaction handling system. The host systems in FIG. 5 make requests of the secure storage processor 30. In turn, the hosts systems are transparently given globally unique identifiers associated with and identifying the stored data or are transparently informed as to the successor or failure of the requested transactions.

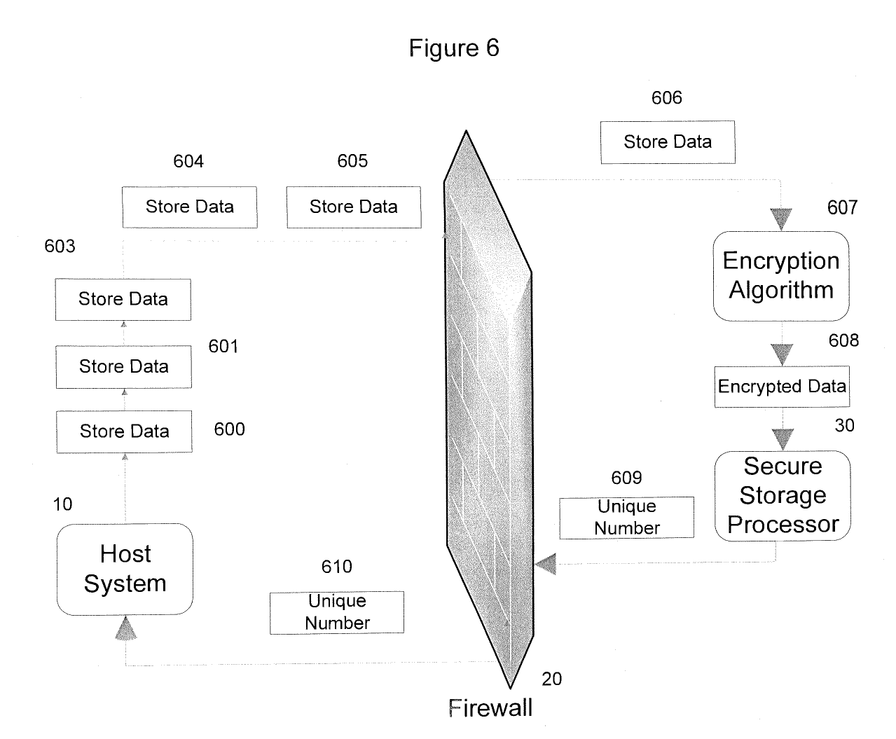

Additionally, the present invention allows host systems to send multiple storage requests at one time, which allows for the bulk upload of sensitive data. FIG. 6 shows a block diagram of a method for processing multiple storage requests according to one embodiment of the present invention. A host system 10 and a secure storage processor 30 are shown. The host system 10 transmits multiple storage requests (600-606) to the secure storage processor 30. The secure storage processor 30 receives storage requests from the host system 10 through a network firewall 20. Once the data to be stored 606 is received from the host system 10, the data is manipulated by an encryption algorithm (step 607) before the data is stored. The encrypted data 608 is stored in the secure storage processor 30 and a globally unique identifier 609 is generated and transmitted to the host system 10, as shown by globally unique identifier 610, for each individual storage request. The host system 10 stores each of the globally unique identifiers, each of which can later be used by the host system 10 to easily refer to the stored encrypted data in future interactions with the secure storage processor 30.

The secure storage system 30 described above has several advantages. In particular, when a new host system 10 begins using the secure storage processor 30, the bulk upload of data through multiple storage requests saves a significant amount of time. Further, the encryption of the data prior to storage, dramatically increases the security of the sensitive data stored in the secure storage processor 30.

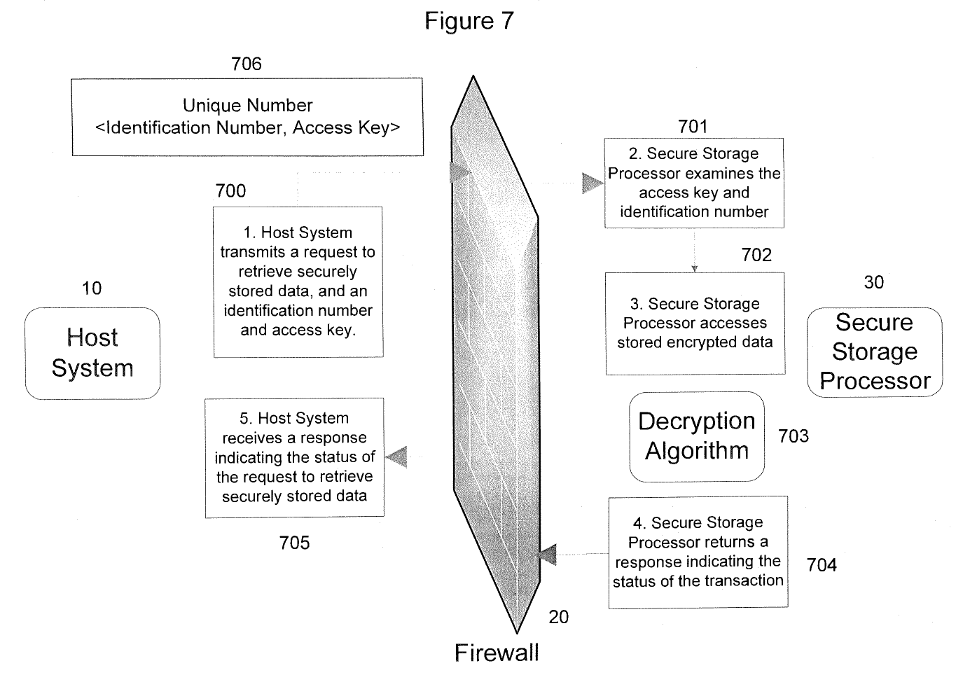

The present invention may also be utilized to retrieve securely stored data. FIG. 7 is a block diagram illustrating a method for retrieving securely stored data according to one embodiment of the present invention. A host system 10 and a secure storage processor 30 are shown. The host system 10 transmits a request to retrieve securely stored encrypted data. In addition, the host system 10 may transmit an identification number and access key (step 700) to the secure storage processor 30.

The secure storage processor 30 receives a retrieval request from the host system 10 through a network firewall 20. Once the secure storage processor 30 has received the request from the host system 10, if the host system 10 transmitted an access key and identification number, the secure storage processor 30 examines the identification number and access key to determine whether the access key matches the identification number prior to proceeding with the stored encrypted data retreival (step 701). The purpose of the identification number and access key is to securely verify the identity of the host system 10 before performing any operations.

Following the evaluation of the access key and identification number (step 701), the secure storage processor 30 accesses the encrypted data (step 702). The secure storage processor 30 accesses the encrypted data via the globally unique identifier tramsmitted with the request to retrieve securely stored encrypted data, wherein the globally unique identification identifier is associated with specific encrypted data stored at the secure storage processor 30. In this case, the specific data is the encrypted data requested by the host system 10. The secure storage processor then manipulates the data using a decryption algorithm (step 703) to decrypt the stored encrypted data requested. Following decryption (step 703), the secure storage processor 30 generates and transmits a response (step 704) indicating the status of the request to retrieve securely stored data. If the securely stored data is successfully retreived (step 702), and successfully decrypted (step 703) by the secure storage processor 30, the response will also contain the requested stored encrypted data in decrypted form. The host system 10 receives the response from the secure storage processor 30 (step 705). The response indicates to the host system 10 whether the request was a failure or a success.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use comtemplated.

What is claimed is:

1. A method of securely receiving, encrypting, and storing encrypted data comprising:
transmitting data from a host system to a secure storage processor;
receiving the data from the host system at a secure storage processor;
encrypting the data;
storing the encrypted data on the secure storage processor;
transmitting a globally unique identifier, identifying the stored encrypted data, from the secure storage processor to the host system; and
storing the globally unique identifier received from the secure storage processor on the host system.

2. The method of claim 1, wherein the receiving step further comprises:
receiving an identification number and access key, wherein the identification number identifies the host system; and
examining the access key to determine whether the access key matches the identification number prior to storing the encrypted data.

3. The method of claim 2, wherein the receiving step further comprises at least two separate storage requests.

4. The method of claim 2, wherein the stored encrypted data is financial information.

5. The method of claim 2, wherein the stored encrypted data is personal information.

6. The method of claim 4, wherein the financial information is credit or debit card information.

7. The method of claim 4, wherein the financial information is automated clearing house data, bank account data, or checking data.

8. The method of claim 4, wherein the financial information is electronic funds transfer data or automated teller machine data.

9. The method of claim 5, wherein the personal information is social security information.

10. The method of claim 5, wherein the personal information is health insurance information.

11. A method for securely storing data comprising:
receiving data from a host system;
encrypting the data;
storing the encrypted data; and
transmitting a globally unique identifier identifying the stored encrypted data to the host system.

12. A method for processing securely stored data comprising:
receiving a request to process a transaction from a host system, wherein the request includes a globally unique identifier associated with stored encrypted data in a secure storage processor;
processing the transaction; and
returning a response to the host system indicating a status of the transaction.

13. The method of claim 12, wherein the transaction is a financial transaction and the stored encrypted data is financial information.

14. The method of claim 12, wherein the transaction is a personal information transaction wherein the stored encrypted data is personal information.

15. The method of claim 13, wherein the financial information is credit card or debit card data.

16. The method of claim 13, wherein the financial information is automated clearing house data, bank account data, or checking data.

17. The method of claim 13, wherein the financial information is electronic funds transfer data or automated teller machine data.

18. The method of claim 14, wherein the personal information is social security information.

19. The method of claim 14, wherein the personal information is health insurance information.

20. A method for retrieving securely stored data comprising:
receiving a request to retrieve securely stored encrypted data from a host system, wherein the request includes a globally unique identifier associated with the stored encrypted data in a secure storage processor;
retrieving the securely stored encrypted data associated with the globally unique identifier;
decrypting the stored encrypted data; and
returning a response to the host system, wherein the response indicates a status of the request to retrieve securely stored data, and the stored encrypted data in decrypted form, if the requested data is successfully retrieved.

21. A method for processing securely stored data comprising:
receiving a user request to perform a credit card transaction with credit card data;
transmitting the credit card data from a host system to a secure storage processor;
receiving the credit card data from the host system at a secure storage processor;
encrypting the credit card data;
storing the encrypted credit card data on the secure storage processor;
transmitting a globally unique identifier identifying the encrypted credit card data from the secure storage processor to the host system;
storing the globally unique identifier received from the secure storage processor on the host system;
receiving a request to process the credit card transaction from the host system, wherein the request includes a globally unique identifier associated with the encrypted credit card data stored in the secure storage processor;
processing the credit card transaction; and
returning a response to the host system indicating to the user a status of the credit card transaction.

22. A method of securely storing data comprising:
transmitting data to a secure storage processor;
receiving a globally unique identifier identifying the stored encrypted data from the secure storage processor; and
storing the globally unique identifier received from the secure storage processor.

23. The method of claim 22, wherein the transmitting step further comprises transmitting an identification number and an access key to the secure storage processor.

24. A system for securely storing data comprising:
a host system; and
a secure storage processor connected to the host system via a network, wherein the secure storage processor is configured to receive data from the host system, encrypt the received data, store the data, and transmit a globally unique identifier identifying the stored encrypted data to the host system.

25. The system of claim 24, wherein the secure storage processor may be further configured to receive an identification number and/or username and a* access keys and/or passwords, whereby the identification number identifies the host system.

26. The system of claim 24, wherein the secure storage processor may be further configured to examine the access key to determine whether the access key matches the identification number prior to storing the encrypted data.

27. A system for processing securely stored data comprising:
a host system; and
a secure storage processor connected to the host system via a network, wherein the secure storage processor is configured to receive a request to process a transaction and a globally unique identifier associated with stored encrypted data in the secure storage processor from the host system, process the transaction, and return a response to the host system indicating the status of the transaction.
